(19) United States
(12) Patent Application Publication
(10) Pub. No.: US 2015/0073886 A1
(43) Pub. Date: Mar. 12, 2015

(54) NEAR FIELD COMMUNICATION ENABLED PURCHASING MECHANISMS

(71) Applicant: Robert P. Sabella, Richardson, TX (US)

(72) Inventor: Robert P. Sabella, Richardson, TX (US)

(21) Appl. No.: 14/482,464

(22) Filed: Sep. 10, 2014

Related U.S. Application Data
(60) Provisional application No. 61/875,917, filed on Sep. 10, 2013.

(51) Int. Cl. G06Q 20/32; G06Q 30/06; G06Q 30/02; H04B 5/00

(52) U.S. Cl. CPC G06Q 20/3278; H04B 5/0056; G06Q 30/0633; G06Q 30/0214
USPC 705/14.16; 705/26.8

(57) ABSTRACT

A method of placing an order performed by a mobile computing device. The method includes the steps of reading a near field communication element on or in a product, determining characteristics of the product based on the step of reading the near field communication element, and accessing or acquiring information about a user of the mobile computing device. The method also includes the steps of combining at least some of the characteristics of the product and at least some of the information about the user, and placing the order based on the step of combining. The characteristics of the product may include a product number or identifier, and the information about the user may include a size for the product.

### CROSS-REFERENCE TO RELATED APPLICATION

This application claims the benefit of U.S. Provisional Application No. 61/875,917 titled “NEAR FIELD COMMUNICATION ENABLED PURCHASING MECHANISMS” and filed 10 Sep. 2013 in the name of the same inventor as this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to a purchasing mechanism that is enabled by near field communication.

### SUMMARY

Aspects of the subject technology include a method of placing an order performed by a mobile computing device. The method includes the steps of reading a near field communication element on or in a product, determining characteristics of the product based on the step of reading the near field communication element, and accessing or acquiring information about a user of the mobile computing device. The method also includes the steps of combining at least some of the characteristics of the product and at least some of the information about the user, and placing the order based on the step of combining The characteristics of the product may include a product number or identifier, and the information about the user may include a size for the product.

Aspects of the subject technology also include a mobile computing device such as a mobile phone configured to perform the foregoing method.

This brief summary has been provided so that the nature of the invention may be understood quickly. A more complete understanding of the invention may be obtained by reference to the following description in connection with the attached drawings.

### BRIEF DESCRIPTION OF THE DRAWINGS

FIG. 1 shows an environment in which a mobile computing device may be used in conjunction with near field communication to purchase a product according to aspects of the subject technology.

FIG. 2 shows a flow diagram for a process performed by a mobile computing device to use near field communication to enable purchasing a product according to aspects of the subject technology.

FIG. 3 shows a flow diagram for a process of using near field communication to enable tracking of product usage and purchasing of products according to aspects of the subject technology.

### DETAILED DESCRIPTION OF THE INVENTION

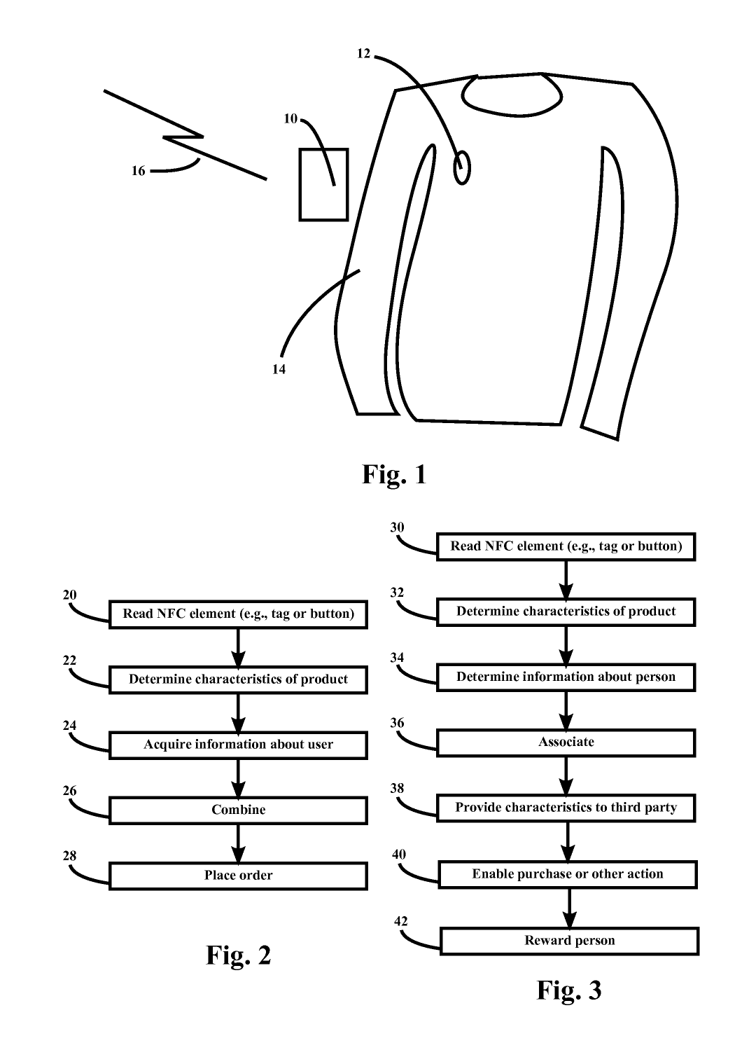

FIG. 1 shows an environment in which a mobile computing device may be used in conjunction with near field communication to purchase a product according to aspects of the subject technology. Mobile computing device 10 is enabled to read near field communication element 12. Thus, mobile computing device 10 includes at least one or more tangible computing elements, at least one memory that may store information instructions, and at least one near field communication scanner. Examples of mobile computing device 10 include but are not limited to mobile phones, tablet computers, PDAs, and the like.

Near field communication (i.e., NFC) element 12 is a type of radio frequency identifier (i.e., RFID) element that is designed to be readable at very short ranges such as a few centimeters. In FIG. 1, near field communication element 12 is attached to or part of product 14, which is illustrated as a shirt. Near field communication elements can be attached to or part of products such as shirts and other garments as well as practically any other types of products. In some aspects, particularly in the case of garments, near field communication element 12 may take the form of a button or tag with a near field communication element embedded therein.

In some aspects, the near field communication element includes data representing characteristics of the product to which it is attached. For example, the near field communication element may include data representing a product number or identifier, a source for a product (e.g., manufacturer, retailer, wholesaler, country of origin such as “made in the USA,” and/or the like), a product description, and/or the like. When the near field communication element is read, some or all of this data may be passed to the reading device.

Mobile computing device 10 in FIG. 1 may use the data read from a near field communication element to order the product or a similar product corresponding to the near field communication element. For example, an order for the product may be made over wireless link 16, which may be a wireless phone network link, a WiFi link, or any other wireless link. Alternatively, an order may be placed over a wired connection to another computing device, possibly at a later time when such a connection becomes available.

FIG. 2 shows a flow diagram for a process performed by a mobile computing device to use near field communication to enable purchasing a product according to aspects of the subject technology. This process may be performed by a mobile computing device in an environment such as the one illustrated in FIG. 1.

In step 20, a mobile computing device reads a near field communication element that is attached to, part of, or otherwise associated with a product, for example when a user “taps” such a near field communication element. The data from the near field communication element may include characteristics of the product and/or may identify a source for such characteristics. The mobile computing device determines at least some of these characteristics in step 22.

The mobile computing device accesses or acquires information about a user of the device in step 24. (In this context, “accesses or acquires” may include both accessing and acquiring.) The information may have been stored in the mobile computing device earlier, may be accessed by the mobile computing device from another source such as over a wireless connection to a server or the Internet, and/or may be acquired directly from the user. Examples of such information include but are not limited to sizes for different products that the user wears (e.g., large for shirts, 32″×32″ for pants, size 10 for shoes, etc.), a shipping address for purchase of products, payment information associated with the user, and/or the like.

In step 26, at least some of the characteristics of the product are combined with at least some of the information about the user. In some aspects, the user might be queried by the mobile device to verify, add to, modify, change, and/or exclude some of the product characteristics and/or user information. For a first example, in an event some characteristics and/or information are missing, the user may also be queried for the missing characteristics and/or information. For a second example, the user might be asked to verify use of a particular payment method and/or provide a different payment method. For a third example, the user might be asked if the user wants to change some characteristics of the product, for example a color of the product. In these examples, the characteristics and/or information input by the user may be stored locally or remotely for later transactions.

An order is placed based by the mobile device in step 28, possibly after final verification by the user that the order is correct and should be placed. For example, the mobile computing device may determine a retailer that sells products of the same type as the product associated with the read near field communication element, access a website or portal for the retailer, and place the order with the online retailer through the website or portal. The retailer may be an online retailer, a “brick and mortar” retailer who accepts orders online, or the like.

In other aspects, mobile computing device 10 may be used to associate near field communication (i.e., NFC) element 12 with private information uploaded by a user, for example to an online database, website, or cloud computing infrastructure. The mobile computing device may be configured by an application, other software, and/or hardware to perform this function. The private information associated with NFC element 12 may be, for example, information identifying the person, contact information, social media information, business information, songs, videos, pictures, other media, and basically any other form of digital information.

In some aspects, the user may “take ownership” of NFC element and hence the associated product by scanning the NFC element. An application, other software, and/or hardware on the mobile computing device, either alone or in conjunction with a website, online portal, or the like, may then be used to access private information about the person. This information may have been stored previously or may be stored contemporaneously, for example in the mobile computing device, an online database, a website, or cloud computing infrastructure. The NFC tag may then be associated with the private information, for example in the place where the private information is stored or in another place. This process is one example of the person “taking ownership” of the NFC element and hence the associated product.

In some aspects, the private information may be used to “manage” products, for example by tracking a number of times a NFC element associated with a piece of clothing is scanned during a period of time. Each scan may represent, for example, a use of the product such as wearing a piece of clothing.

In some aspects, NFC element 12 may be placed on or in a product such as clothing in an inconspicuous position that can be easily passed over a third party's mobile computing device or other type of NFC scanner. This scanner may be owned by an establishment and may be positioned in an easily accessible location. For example, an NFC element may be placed in or on a shoulder or sleeve of a shirt, and an establishment's scanner may be placed on a wall. Thus, the person may run their arm or shoulder over the scanner in an inconspicuous fashion. Alternatively, more conspicuous scanning arrangements may be used.

When a person scans their NFC element with an establishment's scanner, that person may be considered to have “checked in” to that location. Both information about the product associated with the NFC element and the person's private information may be scanned. Thus, the establishment may be able to collect valuable analytics about patrons and their clothing or other products.

In still further aspects, a person might see that another person is wearing clothing or using a product that they like. That person may use a mobile computing device to “log into” a database maintained by the establishment. The person may then see what types of clothing and/or other products have been “checked in” to the establishment. If the clothing or other product shows up on the database, the listing for that clothing or other product may include data representing characteristics of the product. Preferably, that data may be sufficient for the person to purchase or take some other action with respect to the product, either directly or through another party.

Furthermore, the establishment's database may include or be able to access private information about the person who checked the product into the establishment. This information may be used to reward the person who checked in the product when the product is purchased. Alternatively, the establishment may be rewarded for the purchase. The reward may be monetary, a charitable donation made on the person's or establishment's behalf, a discount for use with the establishment or source of the product, or some other form.

Similar databases may be provided for famous people as opposed to establishments, thereby permitting people to check what products those famous people are wearing and/or using. Again, private information about the famous person may be associated with the near field communication element by that person, just not necessarily associated with any establishment. Then, when the near field communication element was scanned by the person, for example in association with a website, the remainder of the process may proceed as described above. This alternative also permits the famous person to receive rewards for people emulating what they wear and/or use. Again, the rewards may be monetary, charitable, discounts, or some other form. It should be noted that this aspect of the subject technology may also be used by non-famous people.

The foregoing systems may be more readily adopted because the personal details of both the person who “checked in” a product and the person who accesses the information associated with the product (possibly including the private information about the person who “checked in” the product) are not necessarily shared among them. At the same time, one person may be able to purchase a product based on where and/or who is wearing or using the product, while the person who “checked in” the product may be suitably rewarded for purchases by others.

FIG. 3 shows a flow diagram for a process that may be used to perform some aspects of the subject technology described above. This process may be performed by any system that includes at least tangible computing elements, a near field communication scanner, and memory that stores at least a database and instructions. The scanner preferably can both read from and write to a near field communication element.

In step 30, a near field communication element that is attached to, part of, or otherwise associated with a product is read. This reading may be performed by a scanner at an establishment or associated with a particular person such as a famous person. The data from the near field communication element may include characteristics of the product and/or may identify a source for such characteristics. The mobile computing device determines at least some of these characteristics in step 32. In addition, a source of private information about the person associated with the product is also determined from reading the near field communication element in step 34. This source may be an online database, website, cloud computing infrastructure, or some other source of information. This information preferably was previously uploaded to an online database, website, cloud computing infrastructure, or the like and associated with the near field communication element by the person who “took ownership” of the NFC element.

The characteristics of the product and the information about the person are associated in step 36 for access by third parties, either based on the establishment or the identity of the person. The characteristics of the product may be accessed by through third parties in step 38, for example via a mobile computing device application, a website, or some other technique. The information preferably is sufficient for the third party to purchase or perform some other action with respect to the product in step 40. The person who “checked in” the product may optionally be rewarded based on this action in step 42, for example via a monetary reward or having a charitable donation made on their behalf.

The computing devices discussed herein generally may be any form of computing devices. The terms “tangible computing elements” and “memory” are intended to be read broadly to encompass any combination of processors, chips, ASICs, storage, disc drives, optical drives, networked computing elements, and the like.

Furthermore, the invention is in no way limited to the specifics of any particular embodiments and examples disclosed herein. For example, the terms “aspect,” “example,” “e.g.,” “alternatively” and the like denote features that may be preferable but not essential to include in some embodiments of the invention. In addition, details shown or disclosed with respect to any one aspect of the invention may be used with other aspects of the invention. Additional elements may be added to various aspects of the invention and/or some disclosed elements may be subtracted from various aspects of the invention without departing from the scope of the invention. Singular items/steps imply plural items/steps and vice versa. Many other variations are possible which remain within the content, scope and spirit of the invention, and these variations would become clear to those skilled in the art after perusal of this application.

What is claimed is:

1. A method of placing an order, comprising the steps of:
reading, by a mobile computing device, a near field communication element on or in a product;
determining, by the mobile computing device, characteristics of the product based on the step of reading the near field communication element;
accessing or acquiring, by the mobile computing device, information about a user of the mobile computing device;
combining, by the mobile computing device, at least some of the characteristics of the product and at least some of the information about the user; and
placing, by the mobile computing device, the order based on the step of combining.

2. A method as in claim 1, wherein the mobile computing device comprises a mobile phone.

3. A method as in claim 1, wherein the near field communication element comprises a button or a tag.

4. A method as in claim 1, wherein the characteristics of the product include one or more of a product number, a product identifier, or a manufacturer, retailer, wholesaler, or country of origin for the product.

5. A method as in claim 1, wherein the information about the user includes a size for the product.

6. A method as in claim 1, wherein placing the order further comprises the steps of:
determining a retailer that sells products of the same type as the product;
accessing a website or portal for the retailer; and
placing the order with the retailer through the website or portal.

7. A mobile computing device comprising:
one or more tangible computing elements;
a near field communication scanner; and
at least one memory storing instructions that, when executed by the one or more tangible computing elements, causes the mobile computing device to perform steps including: (a) reading a near field communication element on or in a product using the near field communication scanner; (b) determining characteristics of the product based on the step of reading the near field communication element; (c) accessing or acquiring information about a user of the mobile computing device; (d) combining at least some of the characteristics of the product and at least some of the information about the user; and (e) placing the order based on the step of combining.

8. A mobile computing device as in claim 7, wherein the near field communication element comprises a button or a tag.

9. A mobile computing device as in claim 7, wherein the characteristics of the product include one or more of a product number, a product identifier, or a manufacturer, retailer, wholesaler, or country of origin for the product.

10. A mobile computing device as in claim 7, wherein the information about the user includes a size for the product.

11. A mobile computing device as in claim 7, wherein placing the order further comprises the steps of:
determining a retailer that sells products of the same type as the product;
accessing a website or portal for the online retailer; and
placing the order with the online retailer through the website or portal.

12. A method of tracking product usage and enabling sales of the product, comprising the steps of:
scanning a near field communication element on or in a product;
determining characteristics of the product based on the step of reading the near field communication element;
determining information about a person associated with the product based on the step of reading the near field communication element;
associating the characteristics of the product and the information about the person;
in response to an inquiry from a third party, providing at least some of the characteristics of the product to the third party;
in response to an action performed by the third party with respect to the product, providing a reward to the person associated with the product.

13. A method as in claim 12, wherein the near field communication element is scanned by a scanner associated with an establishment.

14. A method as in claim 12, wherein the near field communication element is scanned by a scanner associated with the person.

15. A method as in claim 12, wherein the reward comprises a monetary reward or a charitable gift made at the person's direction.

16. A system that tracks product usage and enables sales of the product, comprising:
one or more tangible computing elements; and
at least one memory storing a database and instructions that, when executed by the one or more tangible computing elements, causes the mobile computing device to perform steps including: (a) scanning a near field communication element on or in a product; (b) determining characteristics of the product based on the step of reading the near field communication element; (c) determining information about a person associated with the product based on the step of reading the near field communication element; (d) storing the characteristics of the product and the information about the person in the database; (e) in response to an inquiry from a third party, providing at least some of the characteristics of the product to the third party; and (f) in response to an action performed by the third party with respect to the product, providing a reward to the person associated with the product.

17. A system as in claim 16, wherein the near field communication element is scanned by a scanner associated with an establishment.

18. A system as in claim 16, wherein the near field communication element is scanned by a scanner associated with the person.

19. A system as in claim 16, wherein the reward comprises a monetary reward or a charitable gift made at the person's direction.
